(19) United States
(12) Patent Application Publication
(10) Pub. No.: US 2026/0303468 A1
(43) Pub. Date: Oct. 1, 2026

(54) INFRASTRUCTURE DESIGN VALIDATION BY LLM

(71) Applicant: ORACLE INTERNATIONAL CORPORATION, Redwood Shores, CA (US)

(72) Inventors: Paul Gregory GREENSTEIN, Hopkinton, MA (US); Zbigniew HOLKA, Solihull (GB)

(21) Appl. No.: 19/091,485

(22) Filed: Mar. 26, 2025

(51) Int. Cl. H04L 41/14; H04L 41/16

(52) U.S. Cl. CPC H04L 41/145; H04L 41/16

(57) ABSTRACT

Systems, methods, and other embodiments associated with use of an LLM to validate infrastructure designs are described. In one embodiment, a method accesses a candidate topology for a compute infrastructure and infrastructure requirements that are in human language and are applicable to the candidate topology. The method generates a prompt from the candidate topology and infrastructure requirements, wherein the prompt is configured to cause a validation LLM to validate conformance of the candidate topology to the infrastructure requirements. The method generates, with the validation LLM, a status of validation for the candidate topology in response to the prompt. And, the method autonomously determines, based on the status of validation, whether to (1) issue a configuration instruction to configure a target computer system to have the compute infrastructure or (2) issue a correction instruction to generate a corrected topology when the status of validation is invalid.

### BACKGROUND

Cloud platforms have become popular tools for hosting software applications due to their adaptability, scalability, and accessibility. While the computing environment of a cloud platform is largely virtualized, clients of the cloud platform are tasked with the planning and configuration of physical infrastructure that executes the client's software applications. Designs for logical and physical infrastructure may need to be validated before deployment.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an infrastructure validation system that is associated with use of an LLM to validate infrastructure designs.

FIG. 2 illustrates one embodiment of an infrastructure validation method that is associated with use of an LLM to validate infrastructure designs.

FIG. 3 illustrates an example infrastructure design validation by LLM that is associated with use of an LLM to validate infrastructure designs.

FIG. 4 illustrates an embodiment of a computing system configured with the example systems and/or methods disclosed.

### DETAILED DESCRIPTION

Systems, methods, and other embodiments are described herein that provide validation of infrastructure designs using large language models (LLMs). In one embodiment, an infrastructure validation system is configured to recognize whether an infrastructure design satisfies functional and non-functional infrastructure design requirements written in human language.

At a high level, the infrastructure validation system places requirements for the infrastructure and a candidate design (or, more formally, a candidate topology) for the infrastructure into a prompt to a validation LLM. The validation LLM is specifically trained to evaluate whether or not the candidate design conforms to or complies with the requirements. The infrastructure validation system then evaluates the prompt with the validation LLM to determine whether the candidate design is valid, and should be used as a basis for generating cloud infrastructure, or is invalid, and should be revised before use to correct errors identified by the validation LLM. In this way, the infrastructure validation system automatically determines whether a candidate infrastructure design is or is not valid for a given set of design requirements. In one embodiment, the infrastructure validation system further provides actionable identification of the particular design requirements that are not satisfied by the candidate infrastructure design. In one embodiment, the infrastructure validation system further provides actionable identifications of the particular ways in which the infrastructure design is not valid for the given design requirements.

The infrastructure validation system may be used to assess the validity of logical infrastructure design (of the logic and behavior of a computing system) as well as of physical infrastructure design (of the physical elements and configurations used to realize the computing system). In one embodiment, the infrastructure validation system validates both logical and physical designs for an infrastructure in turn. For example, the infrastructure validation system may be employed in the context of two-phase generation of infrastructure design in which a logical infrastructure topology (LIT) is created based on design requirements as an intermediate step to subsequent creation of a physical infrastructure topology (PIT) based on the LIT and design requirements. In this context, the infrastructure validation system operates to (1) using a first validation LLM, determine that a candidate LIT satisfies the design requirements or identify errors where the LIT does not satisfy the design requirements, and (2) using a second validation LLM, determine that a candidate PIT satisfies the design requirements or identify errors where the PIT does not satisfy the design requirements.

In one embodiment, the infrastructure validation system improves the technology of autonomous infrastructure generation by providing automatic detection of when compute infrastructure designs fail to meet requirements. In one embodiment, the infrastructure validation system improves the technology of autonomous infrastructure generation with increased accuracy of infrastructure design generation by providing a validity check with actionable error descriptions that can trigger a corrective re-generation of the infrastructure design.

### —Definitions—

Infrastructure designs may be referred to herein more formally as infrastructure topologies. As used herein, “infrastructure topology” refers to a description of component configuration in a computing system as a graph (or collection of textual tokens translatable to a graph).

As used herein, “Logical Infrastructure Topology” (LIT) refers to a graph (or collection of textual tokens translatable to a graph) that represents an architecture of a system, focusing on the relationships and interactions between different functional elements or components without specifying the actual physical devices or resources involved. In a LIT, the emphasis is on how various components of the system are functionally organized and interconnected, such as the flow of data, communication paths, and the arrangement of software or service components. A LIT serves as a blueprint that outlines logical structure and behavior of the system, independent of the underlying physical infrastructure that will implement it.

As used herein, “Physical Infrastructure Topology” (PIT) refers to a graph (or collection of textual tokens translatable to a graph) that represents the concrete, real-world implementation of a system's architecture, specifying the actual physical devices, resources, and connections that support the logical components described in the LIT. In a PIT the emphasis is on detailing the specific hardware, network configurations, storage solutions, and other physical elements that will be used to realize the system. For example, this may include specifying devices like servers, routers, switches, IP address ranges, and the physical connections between them. A PIT serves as a mapping of the LIT onto actual infrastructure that will be deployed and managed in a data center or cloud environment.

As used herein, “human language” refers to natural, everyday language used by people to communicate, including written text or spoken dictation that is used to express infrastructure requirements for compute infrastructure. Human language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a changed infrastructure requirement) is “in human language” where the electronic data expresses, records, defines, stores, or otherwise represents textual (written) or vocal (spoken) human language.

As used herein, the term “infrastructure requirements” refers to a human language description of features or functions of a compute infrastructure. The infrastructure requirements detail what the compute infrastructure is to accomplish. The infrastructure requirements may include functional requirements: requirements that describe what functions, behaviors, actions, or tasks the compute infrastructure is to perform. And, the infrastructure requirements may include non-functional requirements, such performance criteria (such as response time, sustained volume of transactions, pace, etc.), operational constraints (e.g., availability, reliability, disaster recovery), technological constraints (e.g., standards compliance, desired technologies or products), and quality attributes (e.g., maximum tolerable defect rate and maintainability). In one embodiment, functional requirements alone are considered for generation of a LIT. In one embodiment, non-functional requirements may be disregarded during generation of a LIT, and are considered for generation of a PIT. And, the infrastructure requirements may further include additional constraints on the compute infrastructure.

No action or function described or claimed herein is performed by the human mind. An interpretation that any action or function can be performed in the human mind is inconsistent with and contrary to this disclosure.

### —Example Infrastructure Validation System—

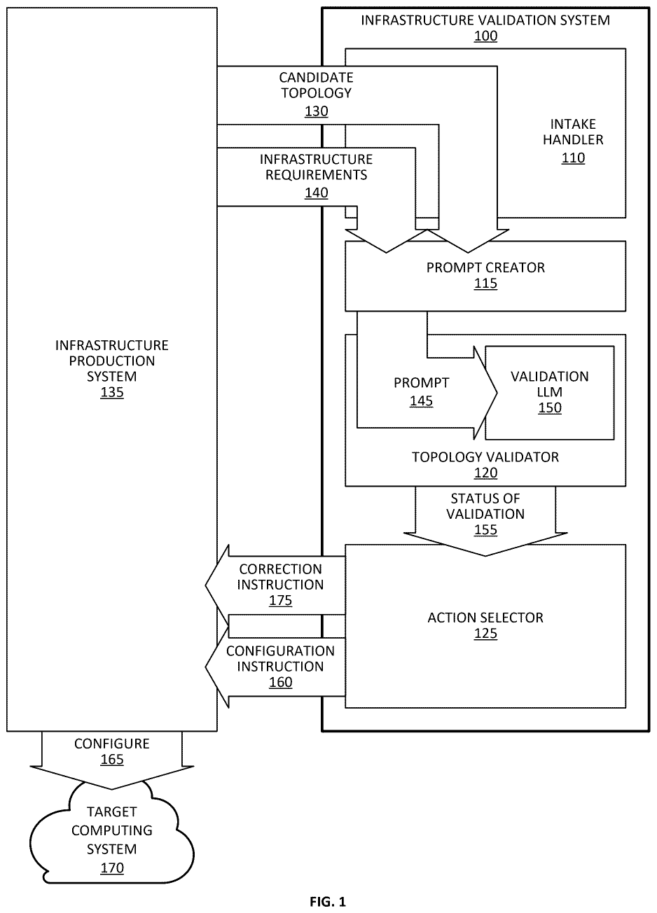

FIG. 1 illustrates one embodiment of an infrastructure validation system 100 that is associated with use of an LLM to validate infrastructure designs. In one embodiment, infrastructure validation system 100 includes various components configured to implement an LLM-based process for evaluating whether a proposed design satisfies requirements or not. Components of infrastructure validation system 100 include an intake handler 110, a prompt creator 115, a topology validator 120, and an action selector 125. In one embodiment, infrastructure validation system 100 is used to evaluate a candidate topology 130 generated by an infrastructure production system 135 for validity and control whether the infrastructure production system 135 deploys infrastructure according to the candidate topology 130 because it is valid or revise the candidate topology 130 because it is invalid. In one embodiment, the components of infrastructure validation system 100 and of infrastructure production system 135 intercommunicate in a network computing system, for example by electronic messages, for example as discussed below under the heading “Cloud or Enterprise Embodiments.”

In one embodiment, intake handler 110 is configured to access a candidate topology 130 for a compute infrastructure and infrastructure requirements 140 that are in human language and are applicable to the candidate topology 130. In one embodiment, prompt creator 115 is configured to generate a prompt 145 from the candidate topology 130 and infrastructure requirements 140. Prompt 145 is configured to cause a validation LLM 150 to validate conformance of the candidate topology 130 to the infrastructure requirements 140. Validation LLM 150 has been trained to determine where an infrastructure topology conforms to given infrastructure requirements, and where (and in what way) an infrastructure topology fails to conform to the given infrastructure requirements. In one embodiment, topology validator 120 is configured to generate, using the validation LLM 150, a status of validation 155 for the candidate topology 130 in response to the prompt 145.

In one embodiment, action selector 125 is configured to autonomously determine, based on the status of validation 155, whether to (1) issue a configuration instruction 160 to proceed to configure 165 a target computer system 170 to have the compute infrastructure or (2) issue a correction instruction 175 to generate a corrected topology. Action selector 125 is configured to issue (1) the configuration instruction 160 to configure the target computer system 175 to have the compute infrastructure based on the candidate topology 130 when the status of validation 155 is valid, and (2) the correction instruction 175 to generate a corrected topology when the status of validation 155 is invalid.

In one embodiment, prompt creator 115 is configured to generate the prompt 145 to include instructions configured to cause validation LLM 150 to generate a listing of validation errors that cause the status of validation to be invalid, along with descriptions of the errors. When generating the status of validation 155, topology validator 120 is configured to list the one or more descriptions of the validation errors that caused the status of validation 155 to be invalid. Action selector 125 receives the validation errors and their corresponding descriptions, for example, with this additional information included in or associated with status of validation 155, or as a separate status message. Action selector 125 includes the validation errors and their corresponding descriptions in correction instruction 175.

The candidate topology 130 may be a LIT or a PIT. In one embodiment, when the candidate topology 130 is a PIT, the candidate topology 130 may potentially be excessive or overboard with respect to satisfying one or more of the infrastructure requirements 140. Prompt creator 145 is configured to generate a prompt that causes validation LLM 150 (or another overboard LLM) to determine whether there are one or more overboard errors in which the candidate topology 130 unnecessarily exceeds the infrastructure requirements. The prompt to evaluate the candidate topology for overboard errors may be included in prompt 145, or may be a separate additional prompt. When generating the status of validation 155, topology validator 120 is configured to list the one or more overboard errors and descriptions corresponding to the overboard errors. Action selector 125 receives the overboard errors, for example, with this additional information included in or associated with status of validation 155, or as a separate status message. Action selector 125 includes the overboard errors and their corresponding descriptions in correction instruction 175.

In one embodiment, the candidate topology 130 is a graph written in a graph representation language. In another embodiment, the candidate topology is a deployment specification written in deployment configuration code (such as Terraform HCL configuration files or Ansible YAML playbooks). In one embodiment, intake handler 110 is configured to convert a deployment specification written in deployment configuration code to a graph written in the graph representation language as a pre-processing step before generating prompt 145.

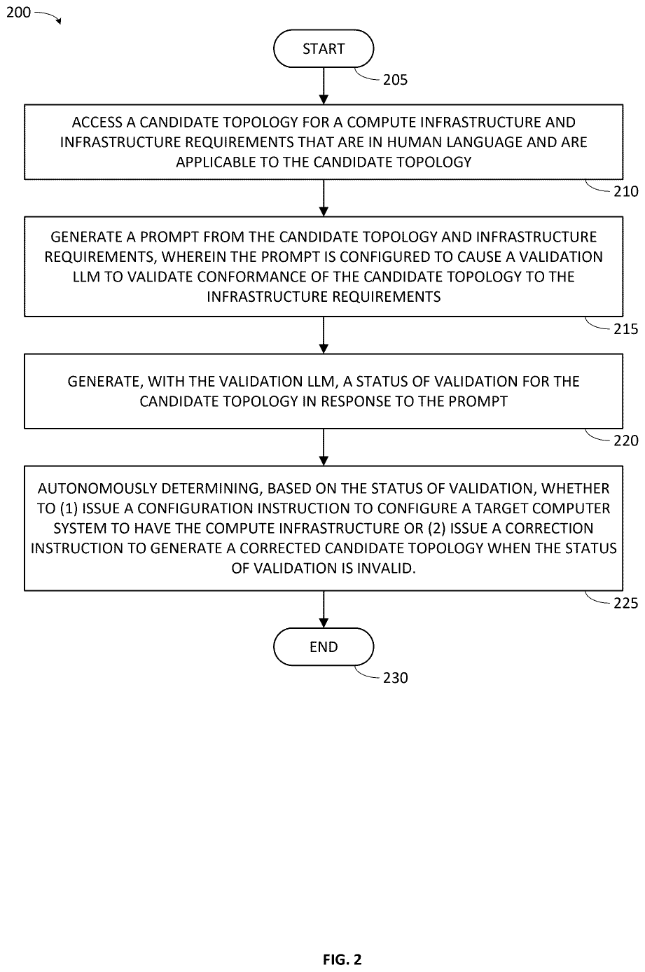

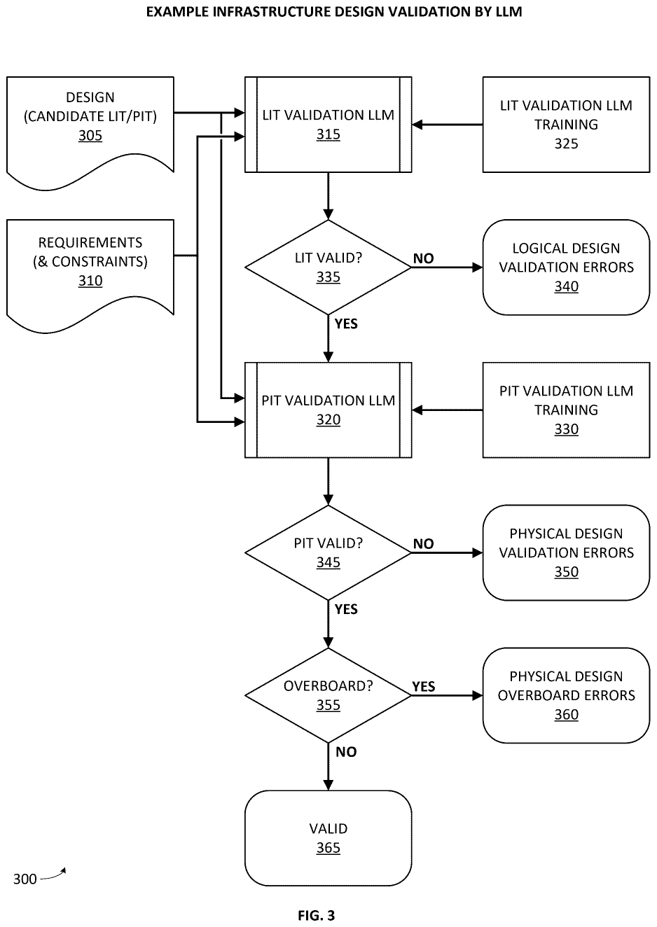

Further details regarding infrastructure validation system 100 are presented herein. In one embodiment, operations of infrastructure validation system 100 will be described with reference to infrastructure validation method 200 of FIG. 2. In one embodiment, operation of infrastructure validation system 100 on both LIT and PIT candidate topologies will be described with reference to example infrastructure design validation by LLM 300 of FIG. 3.

### —Example Infrastructure Validation Method—

FIG. 2 illustrates one embodiment of an infrastructure validation method 200 that is associated with use of an LLM to validate infrastructure designs. In one embodiment, as a general overview, infrastructure validation method 200 gets an infrastructure topology that is a candidate for satisfying a given set of human-language infrastructure requirements. Infrastructure validation method 200 then submits the candidate topology and the infrastructure requirements in a prompt to an LLM. The LLM, referred to herein as a “validation LLM,” is specially trained to determine whether or not infrastructure topologies conform to infrastructure requirements. Infrastructure validation method 200 executes the LLM to generate a status of validation—for example “valid” or “invalid” for the candidate topology in response to the prompt. And, infrastructure validation method 200 chooses to either (1) when the status is “valid,” issue an instruction to configure a target computer system as described by the candidate topology or (2) when the status is “invalid,” issue an instruction to generate a corrected topology.

In one embodiment, infrastructure validation method 200 initiates at START block 205 in response to infrastructure validation system 100 determining that one or more conditions or events have been detected or have occurred. The conditions or events for initiating infrastructure validation method 200, include, but are not limited to: (1) infrastructure validation system 100 has received an instruction to validate a candidate topology against infrastructure requirements; (2) infrastructure validation system 100 has received a pair of a candidate topology and infrastructure requirements against which the candidate topology is to be validated; (3) a user or administrator has initiated infrastructure validation method 200; (4) it is currently a time at which infrastructure validation method 200 is scheduled to be run; or (5) some other condition for commencing infrastructure validation method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of infrastructure validation system 100 executes infrastructure validation method 200. In one embodiment, at START block 205, infrastructure validation system 100 configures compute resources for performing infrastructure validation method 200. (1) infrastructure validation system 100 provisions (i.e., allocates and initializes) resources of the computing system that are used by infrastructure validation system 100, such as processor, memory and storage (for example, for executing components of infrastructure validation system 100). (2) infrastructure validation system 100 establishes access to one or more networks for the resources, such as access to (a) internal networks for communication among components of infrastructure validation system 100 and (b) external networks for communication with other computing systems (for example, infrastructure production system 135 or other client systems). (3) infrastructure validation system 100 connects to data sources (such as databases, data stores, file systems, and cloud storage) used by the infrastructure validation method 200. And, (4) infrastructure validation system 100 configures the computing system with system settings, software dependencies and libraries, and modules for executing the components of infrastructure validation system 100. Following initiation at START block 205, infrastructure validation method 200 proceeds to block 210.

At block 210, infrastructure validation method 200 access a candidate topology for a compute infrastructure and infrastructure requirements that are in human language and are applicable to the candidate topology. The infrastructure validation method 200 gets infrastructure requirements and a candidate topology that, potentially, conforms to the infrastructure requirements. The infrastructure validation method 200 acquires human language that outlines a compute infrastructure along with a graph of a design that may satisfy the outline.

Accessing the candidate topology and infrastructure requirements may take a variety of forms. In one embodiment, an intake handler of the infrastructure validation system includes an API endpoint for requesting validation. This validation API endpoint accepts as input an API request that includes the candidate topology and infrastructure requirements. The infrastructure validation method 200 parses requests received at the validation API endpoint to extract and store the candidate topology and input requirements. In another embodiment, the candidate topology and infrastructure requirements may be provided in files located at provided file paths, as specified records in a database, or received by input (e.g., upload) through a user interface.

The infrastructure requirements are applicable to the candidate topology in the sense that the candidate topology is created, generated, proposed, or otherwise put forth as a configuration that satisfies, complies with, or otherwise conforms to the infrastructure requirements. The infrastructure requirements are in human language, and might therefore be unstructured, or otherwise not follow a particular formal structure. The infrastructure requirements may also include additional constraints (beyond described function) with regard to choice of technology or product.

The candidate topology is one of a LIT or a PIT. The candidate topology may be a topology that has been automatically generated by an LLM based on the infrastructure requirements. The candidate topology is a “candidate” in the sense that, at the time of its provision to the infrastructure validation method 200, the candidate topology has not yet been confirmed to be valid, i.e., confirmed to be a configuration of logical or physical components that conforms to the infrastructure requirements.

The candidate topology may be a graph written as text code in a graph representation language (GRL). Various GRLs may be appropriate for representing the candidate topology, including but not limited to: JSON-Graph, graph modeling language (GML), GraphML, Graphviz DOT, trivial graph format (TGF), and resource description framework (RDF).

The candidate topology might also be a deployment specification (such as an Ansible playbook or Terraform configuration file) written in deployment configuration code (such as YAML or HCL). In this case, infrastructure validation method 200 detects that the candidate topology is a deployment specification rather than a graph, for example by parsing a file extension of the candidate topology that is associated with a deployment specification, or by parsing the code of the candidate topology to determine that it is in deployment configuration code, and not in GRL code. Where the candidate topology is detected to be a deployment specification, infrastructure validation method 200 converts the candidate topology from a deployment specification in configuration code to a graph in GRL code, for example by executing a translation script that is configured to perform such conversion.

In one embodiment, infrastructure validation method 200 access a candidate topology for a compute infrastructure and infrastructure requirements that are in human language and are applicable to the candidate topology by listening at an API endpoint of the infrastructure validation method 200 for a request; in response to receiving a request, parsing the request to extract the candidate topology and infrastructure requirements; and storing the candidate topology and infrastructure requirements in a manner that makes them accessible for subsequent analysis.

In one embodiment, the steps of block 210 are performed by intake handler 110. At the conclusion of block 210, infrastructure validation method 200 has obtained a candidate topology for validation with respect to given infrastructure requirements. Processing continues to block 215.

At block 215, infrastructure validation method 200 generates a prompt from the candidate topology and infrastructure requirements, wherein the prompt is configured to cause a validation LLM to validate conformance of the candidate topology to the infrastructure requirements. Infrastructure validation method 200 assembles a prompt from the candidate topology and infrastructure requirements that instructs a validation LLM to assess the alignment of the topology with the requirements.

In one embodiment, the prompt may include instructions in human language to evaluate the conformity of the candidate topology with the infrastructure requirements, the infrastructure requirements in human language, and the candidate topology in graph representation language code.

In one embodiment, the infrastructure validation method generates the prompt 145 by inserting the candidate topology 130 and infrastructure requirements 140 into a template prompt that requests validation of the candidate topology 130 with respect to the infrastructure requirements. For example, where the candidate topology 130 is a LIT, the template prompt might be something like “State whether or not the following logical infrastructure topology, which is written in [GraphRepresentationLanguage], satisfies the following infrastructure requirements. In the event that the logical infrastructure topology does not satisfy the infrastructure requirements, prepare a list of descriptions of each aspect where the logical infrastructure topology does not satisfy the infrastructure requirements.
Logical Infrastructure Topology: [LogicalInfrastructureTopology]
Infrastructure Requirements: [InfrastructureRequirements].”

Or, in another example where the candidate topology 130 is a PIT, the template prompt might be something like “State whether or not the following physical infrastructure topology, which is written in [GraphRepresentationLanguage], satisfies the following infrastructure requirements. In the event that the physical infrastructure topology does not satisfy the infrastructure requirements, prepare a list of descriptions of each aspect where the physical infrastructure topology does not satisfy the infrastructure requirements.
Physical Infrastructure Topology: [PhysicalInfrastructureTopology]
Infrastructure Requirements: [InfrastructureRequirements].”

In one embodiment, infrastructure validation method 200 generates a prompt from the candidate topology and infrastructure requirements by the following steps. The infrastructure validation method 200 checks to determine whether the candidate topology is a LIT or a PIT, for example by parsing the candidate topology to detect the presence of components that are specific to one or the other of a LIT or PIT, and not to both LIT and PIT. The infrastructure validation method 200 loads a template prompt for a LIT or PIT, corresponding to the type of topology that the candidate topology is detected to be. The template prompt is configured to instruct a validation LLM to state whether or not a current value for a candidate topology variable conforms to a current value for an infrastructure requirements variable. These variables may be text strings. The infrastructure validation method 200 populates the corresponding variable fields of the template prompt with current values for the candidate topology and the infrastructure requirements, as well as values for any additional variables in the template prompt, such as a particular graph representation language. The infrastructure validation method 200 makes the prompt available for use by downstream processes.

In one embodiment, the steps of block 215 are performed by prompt creator 115. At the conclusion of block 215, infrastructure validation method 200 has generated a prompt that is configured to trigger a validation LLM to determine a state of validation for the candidate topology with respect to the infrastructure requirements. Processing continues to block 220.

At block 220, infrastructure validation method 200 generates, with the validation LLM, a status of validation for the candidate topology in response to the prompt. Infrastructure validation method 200 submits the prompt generated in block 215 to the validation LLM, and captures the response by the validation LLM. The infrastructure validation method 200 utilizes the validation LLM to produce a validation status of “valid” or “not valid” for the candidate topology by submitting the previously generated prompt and recording the LLM's response.

In one embodiment, infrastructure validation method 200 generates, with the validation LLM, a status of validation for the candidate topology in response to the prompt by the following process. Infrastructure validation method 200 places the prompt into an API call to the validation LLM. Infrastructure validation method 200 passes the API call (which includes the prompt) to an API endpoint of the validation LLM that is configured for input, and listens at an API endpoint of the validation LLM that is configured for output for the response. Infrastructure validation method 200 executes the validation LLM to process the prompt. The validation LLM evaluates the conformity of the candidate topology to the stated infrastructure requirements based on its training. Infrastructure validation method 200 detects the arrival of the response at the output endpoint and stores the response in memory. Infrastructure validation method 200 parses the response to capture the validation status indicating whether or not the candidate topology meets the infrastructure requirements. (And, in one embodiment, where the candidate topology does not meet the infrastructure requirements, infrastructure validation method 200 parses the response to capture descriptions of validation errors that prevented the candidate topology from satisfying the infrastructure requirements.

In one embodiment, the steps of block 220 are performed by topology validator 120. At the conclusion of block 220, infrastructure validation method 200 has determined whether or not the candidate topology satisfies the infrastructure requirements. This validation status for the candidate topology may be used to trigger subsequent actions, as described below in block 225. Processing continues to block 225.

At block 225, infrastructure validation method 200 autonomously determines, based on the status of validation, whether to (1) issue a configuration instruction to proceed to configure a target computer system to have the compute infrastructure based on the candidate topology or (2) issue a correction instruction to generate a corrected topology. Thus, where the topology is validated successfully (has a validation status of “valid”), infrastructure validation method 200 chooses to proceed onward towards deployment; and if the topology is not validated successfully (has a validation status of “invalid”), infrastructure validation method 200 chooses to start a topology revision process. In one embodiment, the infrastructure validation method 200 either (1) generates and transmits the configuration instruction; or (2) generates and transmits the correction instruction, as described below under the heading “Example-LLM Infrastructure Validation for LLM-Generated Infrastructure.”

In one embodiment, infrastructure validation method 200 autonomously determine, based on the status of validation, whether to (1) issue a configuration instruction to configure a target computer system to have the compute infrastructure or (2) issue a correction instruction to generate a corrected candidate by the following process. Infrastructure validation method 200 determines whether the validation status for the candidate topology is valid or invalid. Where the validation status is valid, infrastructure validation method 200 generates and transmits an electronic message indicating that the candidate topology is valid, which may be processed by an infrastructure production process as indicating the infrastructure production process may move on to a next step toward deployment, such as generating a PIT from a LIT or generating a deployment specification from a PIT.

Where the validation status is invalid, infrastructure validation method 200 loads a template for a corrective prompt. The template for the corrective prompt includes instructions configured to cause a LIT or PIT generation LLM to correct a candidate topology to resolve validation errors. The template for the corrective prompt includes variables for the candidate topology, the infrastructure requirements, and one or more validation errors. Infrastructure validation method 200 populates the template for the corrective prompt with current values for the variables to generate the corrective prompt. Infrastructure validation method 200 composes and transmits an electronic message that includes the corrective prompt to an infrastructure production process, which causes the corrective prompt to be executed by the LIT or PIT generation LLM.

In one embodiment, the steps of block 225 are performed by action selector 125. At the conclusion of block 225, infrastructure validation method 200 has instructed an external process whether to proceed towards deployment of compute infrastructure based on an infrastructure topology that is valid for the infrastructure requirements, or to revise an infrastructure topology that is invalid for the infrastructure requirements. Processing continues to end block 230, where infrastructure validation method 200 concludes.

At the conclusion of infrastructure validation method 200, the infrastructure validation system 100 may return to a waiting state in which the infrastructure validation system 100 awaits satisfaction of a condition to recommence infrastructure validation method 200 beginning from block 210. For example, the infrastructure validation method may repeat one or more iterations of blocks 210-225, in parallel or in a loop, in response to receiving a discrete instruction to validate a candidate topology against infrastructure requirements or satisfaction of some other condition for further iteration of the infrastructure validation method.

### —Example Additional Features of Infrastructure Validation Method—

In one embodiment, the validation LLM is further instructed by the prompt to extract particular validation errors that cause the candidate topology to not conform to the infrastructure requirements (and thereby render the candidate topology invalid) along with descriptions of the errors. For example, when the status of validation indicates the candidate topology to be invalid, infrastructure validation method 200 also generates, with the validation LLM, a listing of one or more descriptions of validation errors that caused the status of validation to be invalid. The descriptions may be in human language. These descriptions of validation errors provide actionable information for correction of the candidate topology to better conform to the infrastructure requirements.

In one embodiment, the infrastructure validation method 200 generates and a corrective prompt that is configured to correct the candidate topology towards validity. The infrastructure validation method 200 then submits the corrective prompt to a topology generation LLM that generates candidate topologies. The corrective prompt is based on the descriptions of the validation errors, and uses the descriptions to explain to the topology generation LLM the particular ways in which the candidate topology is deficient in satisfying the infrastructure requirements. In this way, the infrastructure validation method 200 autonomously corrects the candidate topology to cause it to be valid for the infrastructure requirements. For example, in response to the status of validation indicating the candidate topology to be invalid, the infrastructure validation method populates the correction instruction from the candidate topology, the infrastructure requirements, and the one or more descriptions of validation errors. The correction instruction is configured to cause the topology generation LLM to update the candidate topology with corrections to the validation errors. The infrastructure validation method 200 generates, with the topology generation LLM, the corrected topology.

In one embodiment, the infrastructure validation method 200 provides a further check to ensure that physical infrastructure prescribed by a PIT has not gone overboard beyond what is needed in order to satisfy the infrastructure requirements. For example, where the candidate topology is a physical infrastructure topology, the infrastructure validation method 200 may further determine that there are one or more overboard errors in which the candidate topology unnecessarily exceeds the infrastructure requirements. In one embodiment, the validation LLM (or another overboard LLM dedicated to detection of overboard errors) is trained to identify where, and in what ways, a candidate topology exceeds infrastructure requirements. In response to a prompt including the candidate topology and the infrastructure requirements, the LLM to produces a listing of the overboard errors with associated descriptions. These descriptions of overboard errors provide actionable information for correction of the candidate topology to reduce waste of resources. In one embodiment the validation LLM generates the listing of validation errors and their respective descriptions and listing of overboard errors and their respective descriptions in response to one prompt.

In one embodiment, the infrastructure validation method 200 generates an overboard correction prompt that is configured to adjust the candidate topology toward inexcessive, right-sized allocation of hardware resources. The infrastructure validation method 200 submits the overboard correction prompt to the topology generation LLM. The overboard correction prompt is based on the descriptions of the overboard errors, and uses the descriptions to explain to the topology generation LLM the particular ways in which the candidate topology has overallocated components beyond those needed to satisfy the infrastructure requirements. In this way, the infrastructure validation method 200 autonomously corrects the candidate topology to cause it not to over-allocate compute resources. For example, infrastructure validation method populates the correction instruction from the candidate topology, the infrastructure requirements, and one or more descriptions of overboard errors. The correction instruction is configured to cause the topology generation LLM to update the candidate topology with corrections to the overboard errors. The infrastructure validation method 200 then generates, with the topology generation LLM, the corrected topology. In one embodiment, the corrective prompt and overboard correction prompt are combined in one prompt to the topology generation LLM.

In one embodiment, the validation LLM is trained to read candidate topologies that are described as graphs written in a graph representation language. However, a candidate topology may also be described as a deployment specification written in deployment configuration code. When the infrastructure validation method 200 receives the candidate topology as a deployment specification, the infrastructure validation method 200 translates the candidate topology from deployment configuration code into graph representation language. For example, when the candidate topology is a deployment specification written in deployment configuration code, accessing the candidate topology (as described at block 210) includes steps to convert the deployment specification to a graph written in a graph representation language. For example, the infrastructure validation method 200 may execute a program that maps deployment language code that describes components of an infrastructure topology to graph representation language code that describes the components. In one embodiment, this conversion tool is reversible, and may also be used to generate deployment specifications from validated candidate topologies upon receipt of a configuration instruction 160.

In one embodiment, the infrastructure requirements may include one or more additional constraints that are not related to the functionality of the infrastructure, such as operational constraints, technology and product preferences. For example, the infrastructure requirements may include an additional constraint on the candidate topology to employ a specified technology. Or, for example, the infrastructure requirements may include an additional constraint on the candidate topology to employ a specified product.

In one embodiment, the infrastructure validation method 200 may be used to validate candidate LITs, candidate PITs, or both candidate LITs and PITs. Thus, in one example of the infrastructure validation method 200, the candidate topology is a logical infrastructure topology. And, in another example of the infrastructure validation method 200, the candidate topology is a physical infrastructure topology. In one embodiment, the validation LLM used to validate a LIT is distinct from the validation LLM used to validate a PIT. In particular, the two LLMs may be trained to validate LITs and PITs respectively, as discussed in further detail below.

### —Discussion of Infrastructure Validation—

Computer-readable designs for compute infrastructure can be generated from human language requirements and constraints using LLMs. In one embodiment, the infrastructure validation system described herein is configured to autonomously validate and/or detect errors in LLM-generated infrastructure designs. As a high-level example, a design for compute infrastructure may be generated from human language requirements and constraints by performing steps to translate (using an LLM) the requirements and constraints from human language into a graph of a logical structure for the infrastructure (a LIT), and from the graph of the logical structure to a more detailed graph of physical structure for the infrastructure (a PIT) that follows the initial logical structure for the infrastructure.

At either (or both) of these design generation stages, the infrastructure validation system may be employed to autonomously validate the LLM-generated infrastructure graph (LIT or PIT) for conformance with the design requirements and constraints. For a given infrastructure graph, the validation process either (1) identifies errors that indicate non-conformance with the requirements and constraints by the infrastructure design represented by the infrastructure graph; or (2) confirms the absence of such errors, thereby indicating conformance with the requirements and constraints by the infrastructure design represented by the infrastructure graph.

Once a LIT has been generated and validated to be free of errors, the LIT may be used to generate a PIT. Once a PIT has been generated and validated to be free of errors, the PIT may then be translated to an executable deployment specification. The deployment specification may in turn be executed to implement, in the cloud, infrastructure that conforms to the requirements and constraints.

In one embodiment, independently from generation of LIT and PIT based on a set of requirements for the infrastructure design, a LIT validation LLM and a PIT validation LLM are trained to recognize a valid logical or physical infrastructure, respectively, to ensure satisfaction of functional and non-functional infrastructure design requirements.

Once a logical or physical design, presumably satisfying the requirements, is produced as a graph, the validation LLM (logical or physical, as appropriate) is provided with the requirements and the graph for the design. Based on its training, the validation LLM identifies errors, gaps, and requirements that have not been satisfied.

In one embodiment, the validation LLM may further identify “overboard” cases where more than the infrastructure necessary to satisfy the requirements has been defined by the design generation LLM(s). In overboard designs, the physical components allotted in a PIT are excessive for satisfying the requirements. For example, consider a situation where to satisfy an availability requirement, a cluster of two elements is required, but the design includes a dozen such elements in one cluster. The extra 10 elements in the cluster are in excess of the two needed to satisfy the availability requirement, and are thus an example of where a design has gone overboard.

In addition to the specific requirements, the validation LLM may be provided with a set of additional constraints, such as, e.g., preferred technologies or products. The validation LLM confirms that the additional constraints are satisfied by the LLM-generated designs.

In one embodiment, the requirements are provided to the validation LLM in a human language. In one embodiment, the design is provided to the validation LLM as a design graph (in a graph representation language). In another embodiment, the design is provided as a deployment specification, such as a Terraform or Ansible module, which would be translated into a design graph prior to submission to the validation LLM. The input design could be produced by a human or generated by another LLM.

FIG. 3 illustrates an example infrastructure design validation by LLM 300 (for convenience, referred to herein as “example validation 300”) that is associated with use of an LLM to validate infrastructure designs. Example validation 300 accepts an infrastructure design 305 and infrastructure requirements 310 as inputs. Infrastructure design 305 may include a candidate LIT, a candidate PIT, or both a candidate LIT and candidate PIT for a compute infrastructure. Requirements 310 may include additional constraints on the infrastructure design 305 beyond the requirements 310. The candidate LIT from the infrastructure design 305 is provided to the LIT validation LLM 315. The candidate PIT from the infrastructure design 305 is provided to the PIT validation LLM 320.

LIT validation LLM 315 undergoes LIT validation LLM training 325. LIT validation LLM training 325 is based on LIT training data that includes pairs of example requirements and corresponding example LITs that are labeled as either (1) valid logical designs for the example requirements, or (2) invalid logical designs for the example requirements. PIT validation LLM 320 undergoes PIT validation LLM training 330. PIT validation LLM training 330 is based on PIT training data that includes pairs of example requirements and corresponding example PITs that are labeled as either (1) valid physical designs for the example requirements, or (2) invalid physical designs for the example requirements. LIT validation training 325 and PIT validation training 330 perform similar steps, with LIT validation training 325 training the LIT validation LLM 315 using the LIT training data, and PIT validation training 330 training the PIT validation LLM 320 using the PIT training data. The LIT validation LLM training 325 and PIT validation LLM training 330 (referred to collectively as the training) accesses a batch of training data: one or more pairs of infrastructure topology (LIT or PIT, as appropriate). The LLM is then configured to more accurately respond to a prompt that requests validation that an example infrastructure topology conforms to or satisfies example requirements. For example, the training adjusts weights (or other parameters) of the respective LLM to cause the LLM to respond to the prompt in a manner that is consistent with the label (valid or invalid) assigned to the pair of example infrastructure topology and requirements.

In one embodiment, the LLM is configured to provide explanations of why an invalid topology is inconsistent with requirements, or in other words, has validation errors. In this case, example infrastructure topologies in the training data that are not valid for their associated example requirements may be further associated in the training data with a set of one or more descriptions of the validation errors—statements of particular ways in which the example infrastructure topology is inconsistent with the example requirement. These descriptions may be in human language. The training accesses a batch of training data that includes descriptions of validation errors. The LLM is then configured to more accurately respond to a prompt that requests validation by including explanation of why an infrastructure topology that is invalid does not conform to the requirements. For example, the training adjusts weights or other parameters of the LLM to cause the LLM to respond to the prompt with a set or listing of descriptions of the validation errors that is consistent with the set of one or more descriptions in the training data.

Both LIT validation LLM 315 and PIT validation LLM 320 are configured to generate a status of validation in response to input of a prompt that requests validation of the design 305 (candidate topology) against the requirements 310. The status of validation may (1) indicate that the design 305 is a valid infrastructure topology that does satisfy the requirements 310 or (2) indicate that the design 305 an invalid infrastructure topology that does not satisfy the requirements 310 (and provide a listing of validation errors and descriptions of the errors).

In one embodiment, initially, example validation 300 receives a LIT design 305 (which is a logical infrastructure topology) and requirements 310. LIT design 305 and requirements 310 are included in a request for the LIT validation LLM 315 to validate LIT design 305 against requirements 310. At decision block 335, example validation 300 determines whether the status of validation indicates that the LIT design 305 is or is not valid. Where LIT design 305 not valid (LIT Valid? 335: NO), example validation 300 proceeds to output logical design validation errors 340. Where the logical infrastructure topology is valid (LIT Valid? 335: YES), example validation 300 awaits input of a further PIT design 305.

Further PIT design 305 is a physical infrastructure topology that was generated based on the valid logical infrastructure topology. The further PIT design 305 and requirements 310 are provided in a further prompt that requests the PIT validation LLM 320 to validate the further PIT design 305 against the requirements 310. At decision block 345, example validation 300 determines whether the status of validation indicates that the PIT design 305 is or is not valid. Where PIT design 305 not valid (PIT Valid? 345: NO), example validation 300 proceeds to output physical design validation errors 350. Where the physical infrastructure topology is valid (PIT Valid? 345: YES), example validation 300 proceeds to determine whether the PIT is overboard for the requirements 310 at decision block 355.

In one embodiment, logical design validation errors 340 indicate the specific instances where the logical structure expressed in the LIT design 305 (i.e., the candidate LIT) is inconsistent with the requirements 310. The logical design validation errors may include a description of the error (written in human language), and an identifier (e.g., a number) for the error. The logical design validation errors 340 may be parsed by a LIT generation LLM to in order to re-generate a candidate LIT in which the errors are corrected. Accordingly, the logical design validation errors 340 may be passed back to an infrastructure production system 135, with the descriptions of the logical design validation errors included in correction instruction 175.

In one embodiment, physical design validation errors 350 indicate the specific instances where the physical structure expressed in the PIT design 305 (i.e., the candidate PIT) is inconsistent with the requirements 310. The physical design validation errors may include a description of the error (written in human language), and an identifier (e.g., a number) for the error. The physical design validation errors 350 may be parsed by a PIT generation LLM to in order to re-generate a candidate PIT in which the errors are corrected. Accordingly, the physical design validation errors 350 may be passed back to infrastructure production system 135, with the descriptions of the physical design validation errors 350 included in correction instruction 175.

In one embodiment, where the candidate PIT is valid, the candidate PIT is further checked at block 355 to confirm that the candidate PIT is not overboard (i.e., excessive) for satisfying the requirements 310. In one embodiment, an overboard LLM is used to detect overboard errors 360 of in the physical design. The overboard LLM used to detect overboard errors 360 is configured to label infrastructure topologies as overboard or not overboard (at block 355). Where a candidate PIT is overboard (overboard? 355: YES), the overboard LLM is configured to provide explanations in the overboard errors 360 of how a topology is excessive in view of the requirements, or in other words, has gone overboard.

In this case, example infrastructure topologies in the training data that unnecessarily exceed the example requirements (for example, by more than a threshold amount) may be labeled in the training data as overboard. The overboard LLM used to detect overboard errors may further be configured to provide descriptions of the overboard errors 360—statements of particular ways in which the infrastructure topology is excessive for associated requirements. The training of the overboard LLM accesses a batch of training data that includes example infrastructure topologies that are overboard for their associated example requirements (i.e., have overboard errors), and, in one embodiment, a set of descriptions of the overboard errors. The overboard LLM is then configured to more accurately respond to a prompt that requests an overboard check, including explanation of why an infrastructure topology that is overboard exceeds the requirements. For example, the training adjusts weights (or other parameters) of the respective overboard LLM to cause the LLM to respond to the prompt in a manner that is (1) consistent with the label (overboard or not overboard) assigned to the pair of example infrastructure topology and requirements; and (2) provides a set of descriptions of the overboard errors that is consistent with the set of one or more descriptions of overboard errors in the training data.

Where a candidate PIT is not overboard (overboard? 355: NO), the example validation 300 concludes that the candidate PIT is valid 365 for the requirements 310. In one embodiment, example validation 300 then returns the validated candidate PIT to infrastructure production system 135, for example included in configuration instruction 160, for deployment to a target computing system 170.

### —Example-LLM Infrastructure Validation for LLM-Generated Infrastructure—

In one embodiment, the infrastructure validation system 100 is used in conjunction with infrastructure production system 135 to confirm that LLM-generated infrastructure topologies satisfy the requirements from which they were generated. An example process illustrating the interaction between the infrastructure production system 135 and infrastructure validation system 100 is described below.

The infrastructure production system 135 accesses infrastructure requirements for a proposed infrastructure. The infrastructure requirements are in human language. The infrastructure production system 135 uses the infrastructure requirements in a two-stage process for LLM-generation of a PIT that satisfies the infrastructure requirements. The infrastructure production system 135 instructs a LIT generation LLM to create a LIT from the infrastructure requirements, and then instructs a PIT generation LLM to create a PIT from the LIT and the infrastructure requirements. The LIT generation LLM is trained to generate LITs from human language requirements, and the PIT generation LLM is trained to generate PITs from LITs and human language requirements that were used to create the LITs. The LITs and PITs are generated in graph representation language.

In this example, at both LIT and PIT generation stages the infrastructure generation system 135 requests validation of the LLM-created infrastructure topology from the infrastructure validation system 100. For example, as inputs, the infrastructure submits the LLM-created infrastructure topology to the infrastructure validation system 100 as the candidate topology 130, and also passes the infrastructure requirements 140 to the infrastructure validation system 100.

Accordingly, once a LIT has been generated by the LIT generation LLM from the infrastructure requirements, the infrastructure production system 135 submits the generated LIT to the infrastructure validation system 100 as a candidate topology 130 for validation, along with the infrastructure requirements 140 from which the LIT was generated.

Using the prompt creator 115, the infrastructure validation system 100 detects that the candidate topology 130 submitted from the infrastructure production system 135 is a LIT, and generates a prompt 145 to a LIT validation LLM 150 that is configured to cause the LIT validation LLM to determine whether the candidate topology 130 is a valid LIT for the infrastructure requirements 130. The prompt 145 is generated by inserting the candidate topology and infrastructure requirements into a template prompt for LIT validation that is configured to request validation of a LIT with respect to infrastructure requirements.

Using the topology validator 120, the infrastructure validation system 100 then submits the populated prompt to the LIT validation LLM. The infrastructure validation system 100 executes the LIT validation LLM on the prompt, and captures the response by the LIT validation LLM. The infrastructure validation system 100 parses the captured response to determine the status of validation 155 determined by LIT validation LLM: valid, or not valid. Where the LIT was found to be invalid, the infrastructure validation system 100 also parses the response to extract one or more descriptions of validation errors for the LIT.

Where the status of validation 155 is not valid, the action selector 125 generates a correction instruction 175 regarding the LIT. In one embodiment, the action selector composes a corrective prompt to the LIT generation LLM, and includes it in the correction instruction 175. The corrective prompt may include the list of LIT validation errors. For example, the corrective prompt may be something like “The following logical infrastructure topology does not conform to the following infrastructure requirements for the reasons listed below. Regenerate given logical infrastructure topology to correct for each of the listed validation errors.
Logical Infrastructure Topology: [LogicalInfrastructureTopology]
Infrastructure Requirements: [InfrastructureRequirements]
List of validation errors: [LITValidationErrors]”.

Brackets in a template prompt indicate variables that may be replaced with current values. In one embodiment, the correction instruction 175 is an electronic signal or message indicating to the infrastructure production system that the LIT is not valid, and that the infrastructure production process should generate a corrected LIT in which one or more (or all) of the LIT validation errors is resolved.

In response to receiving the correction instruction 175, the infrastructure production system 135 submits the corrective prompt to the LIT generation LLM. The LIT generation LLM executes on the prompt and responds with a corrected LIT. In an additional iteration of the validation process, the infrastructure production system 135 then submits the corrected LIT to the infrastructure validation system 100 as a candidate topology 130 for validation, along with the infrastructure requirements 140. This loop may iterate repeatedly until the candidate LIT achieves a status of validation 155 that is valid, and has no LIT validation errors.

Where the status of validation 155 is valid, the action selector 125 generates a configuration instruction 160 regarding the LIT. Because the LIT is an intermediate step toward generation of a physical infrastructure topology, the configuration instruction 160 indicates that the infrastructure production system 135 should proceed to the next step of configuring the target computing system to have the compute infrastructure: generation of a PIT from the generated LIT and the infrastructure requirements. In one embodiment, the configuration instruction 160 is an electronic signal or message indicating to the infrastructure production system 135 that the LIT is valid, and that the infrastructure production process may proceed using the valid LIT.

In response to receiving the configuration instruction 160, infrastructure production system 135 then proceeds to generate a PIT from the valid LIT and the infrastructure requirements using a PIT generation LLM. Once the PIT has been generated, the infrastructure production system 135 submits the generated PIT to the infrastructure validation system 100 as a candidate topology 130 for validation, along with the infrastructure requirements 140 from which the PIT was generated.

Using the prompt creator 115, the infrastructure validation system 100 detects that the candidate topology 130 submitted from the infrastructure production system 135 is a PIT, and generates a prompt 145 to a PIT validation LLM 150 that is configured to cause the PIT validation LLM to determine whether the candidate topology 130 is a valid PIT for the infrastructure requirements 130. The prompt 145 is generated by inserting the candidate topology and infrastructure requirements into a template prompt for PIT validation that is configured to request validation of a PIT with respect to infrastructure requirements.

Using the topology validator 120, the infrastructure validation system 100 then submits the populated prompt to the PIT validation LLM. The infrastructure validation system 100 executes the PIT validation LLM on the prompt, and captures the response by the PIT validation LLM. The infrastructure validation system 100 parses the captured response to determine the status of validation 155 determined by PIT validation LLM: valid, or not valid. Where the PIT was found to be invalid, the infrastructure validation system 100 also parses the response to extract one or more descriptions of validation errors for the PIT.

Where the status of validation 155 for the PIT is not valid, the action selector 125 generates a correction instruction 175 regarding the PIT. In one embodiment, the action selector composes a corrective prompt to the PIT generation LLM, and includes it in the correction instruction 175. The corrective prompt may include the list of PIT validation errors. For example, the corrective prompt may be something like “The following physical infrastructure topology does not conform to the following infrastructure requirements for the validation errors listed below. Regenerate the physical infrastructure topology given below to correct for each of the listed errors.
Physical Infrastructure Topology: [PhysicalInfrastructureTopology]
Infrastructure Requirements: [InfrastructureRequirements]
Validation Errors: [PITValidationErrors]”.

In one embodiment, the correction instruction 175 is an electronic signal or message indicating to the infrastructure production system that the PIT is not valid, and that the infrastructure production process should generate a corrected PIT in which one or more (or all) of the PIT validation errors is resolved.

In response to receiving the correction instruction 175 regarding the PIT, the infrastructure production system 135 submits the corrective prompt to the PIT generation LLM. The PIT generation LLM executes on the prompt and responds with a corrected PIT. In an additional iteration of the validation process, the infrastructure production system 135 then submits the corrected PIT to the infrastructure validation system 100 as a candidate topology 130 for validation, along with the infrastructure requirements 140. This loop may iterate repeatedly until the candidate PIT achieves a status of validation 155 that indicates that the candidate PIT is valid, and has no PIT validation errors.

Where the status of validation 155 is valid, the action selector 125 generates a configuration instruction 160 regarding the PIT. The configuration instruction 160 indicates that the infrastructure production system 135 should proceed to the next step of configuring the target computing system to have the compute infrastructure: conversion of the validated PIT into an executable deployment specification. In one embodiment, the configuration instruction 160 is an electronic signal or message indicating to the infrastructure production system 135 that the PIT is valid, and that the infrastructure production process may proceed using the valid PIT.

In one embodiment, before the infrastructure production system 135 converts the validated PIT into an executable deployment specification, the infrastructure validation system 100 confirms that the valid PIT is not overboard. The infrastructure validation system 100 generates a prompt to an overboard LLM. The overboard LLM is configured to evaluate whether or not a valid PIT is overboard for the infrastructure requirements from which the PIT was generated. The prompt instructs the overboard LLM to generate an overboard status of whether the valid PIT is overboard or not overboard for the infrastructure requirements, and if overboard, to provide a list of overboard errors describing particular instances where the valid PIT is overboard for the infrastructure requirements. The infrastructure validation system 100 executes the overboard LLM on the prompt, and captures the response to the prompt.

Where the valid PIT is not overboard, the infrastructure validation system 100 instructs the infrastructure production system 135 to proceed to the conversion step (for example, in the configuration instruction 160). Where the valid PIT is overboard, the infrastructure validation system 100 instructs the infrastructure production system 135 to further revise the valid LIT to correct the overboard errors. For example, the infrastructure validation system 100 may populate a template prompt for overboard correction such as “The following physical infrastructure topology unnecessarily exceeds minimums for satisfying the following infrastructure requirements for the reasons listed below. Regenerate the physical infrastructure topology provided below to correct for each of the listed overboard errors.
Physical Infrastructure Topology: [PhysicalInfrastructureTopology]
Infrastructure Requirements: [InfrastructureRequirements]
Overboard Errors: [OverboardErrors]”.

The populated overboard correction prompt may be included in the correction instruction 175.

In response to receiving the overboard correction prompt regarding the PIT, the infrastructure production system 135 submits the overboard correction prompt to the PIT generation LLM. The PIT generation LLM executes on the prompt and responds with a corrected PIT in which the overboard errors are resolved. In an additional iteration of the validation process, the infrastructure production system 135 then submits the corrected PIT to the infrastructure validation system 100 as a candidate topology 130 for re-validation after the adjustments to correct the overboard errors, along with the infrastructure requirements 140, and for a further overboard check. This loop may iterate repeatedly until the candidate PIT achieves a status of validation 155 and overboard status that indicate that the candidate PIT is valid, and has no PIT validation errors or overboard errors.

Infrastructure production system 135 converts the validated, non-overboard PIT into an executable deployment specification. For example, infrastructure production system 135 may execute a script or other tool that is configured to map the components of the PIT to code that is executable by an orchestration engine (such as YAML code for Ansible or HCL for Terraform). Infrastructure production system (1) parses the PIT to identify components of the topology, for example, based on pre-specified attributes associated with the components such as type, size, location, or function of the component withing the compute infrastructure; (2) generates configuration blocks of code to implement the identified components; and (3) writes them in appropriate order into a deployment specification (such as an Ansible YAML playbook or a Terraform HCL configuration file. The validated, non-overboard PIT is thereby converted into a set of configuration instructions that can be autonomously carried out by a computer to set up and deploy compute infrastructure as arranged in the PIT.

Infrastructure production system 135 then executes the deployment specification with an orchestration engine (e.g., Ansible or Terraform) to deploy compute infrastructure configured as indicated by the validated, non-overboard PIT into the target computing system 170. In one embodiment, infrastructure production system 135 parses the deployment specification to determine the declarations or sequence of actions for provisioning and configuring in the target computing system 170 the infrastructure that is described by the validated, non-overboard PIT; executes the declarations or sequence of actions to provision and configure the infrastructure in the target computing system 170, and thereby outputs a fully configured target computer system 170. The infrastructure validation system 100 ensures that the configured target computer system 170 satisfies the compute infrastructure outlined in the human-language infrastructure requirements.

### —Cloud or Enterprise Embodiments—

In one embodiment, the present system (such as infrastructure validation system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, infrastructure validation system 100 is a centralized server-side application that provides at least the functions disclosed herein and that is accessed by many users by way of computing devices/terminals communicating with the computers of infrastructure validation system 100 (functioning as one or more servers) over a computer network. In one embodiment infrastructure validation system 100 may be implemented by a server or other computing device configured with hardware and software to implement the functions and features described herein.

In one embodiment, the components of infrastructure validation system 100 may be implemented as sets of one or more software modules executed by one or more computing devices specially configured for such execution. In one embodiment, the components of infrastructure validation system 100 are implemented on one or more hardware computing devices or hosts interconnected by a data network. For example, the components of infrastructure validation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of infrastructure validation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of infrastructure validation system 100 may (i) generate or compose an electronic message or signal to issue a command or request to another component, (ii) transmit the message or signal to other components of infrastructure validation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by infrastructure validation system 100, for example through a web interface server. In one embodiment, the remote computing system may send requests to and receive responses from infrastructure validation system 100. In one example, access to the information or applications may be effected through use of a web browser on a personal computer or mobile device. In one example, communications exchanged with infrastructure validation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of infrastructure validation system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, infrastructure validation systems and methods described herein may be implemented by using a computer program product, comprising computer program/instructions which, when executed by a processor, cause the processor to perform any of the methods described in the disclosure.

### —Computing Device Embodiment—

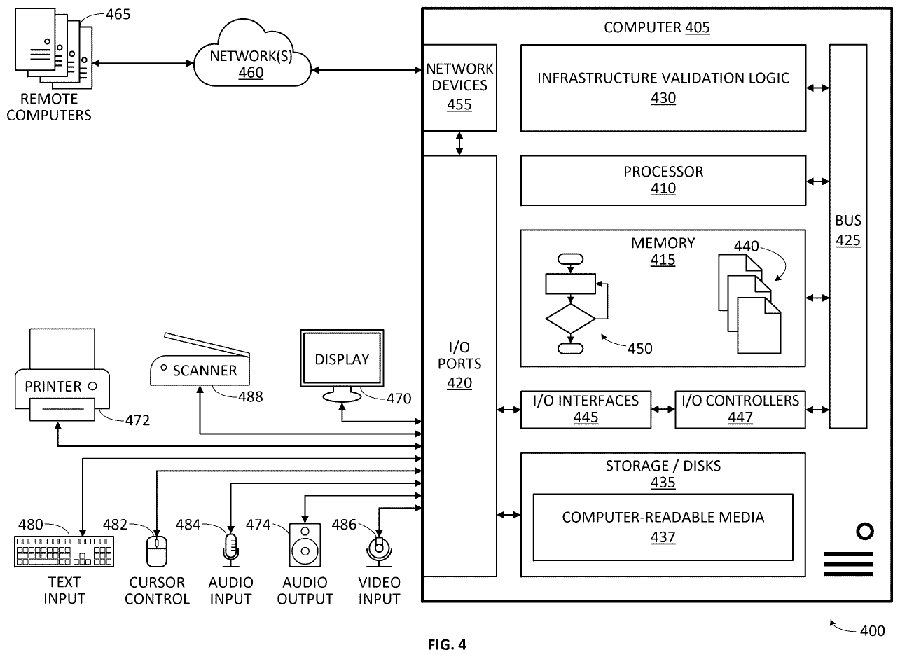

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include infrastructure validation logic 430 configured to facilitate validation of infrastructure designs using large language models, similar to logic, systems, and methods shown in and described with respect to FIGS. 1, 2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate validation of infrastructure designs using large language models. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### —Definitions and Other Embodiments—

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computer system cause the computer system to:
access a candidate topology for a compute infrastructure and infrastructure requirements that are in human language and are applicable to the candidate topology;
generate a prompt from the candidate topology and infrastructure requirements, wherein the prompt is configured to cause a validation LLM to validate conformance of the candidate topology to the infrastructure requirements;
generate, with the validation LLM, a status of validation for the candidate topology in response to the prompt; and
issue (1) a configuration instruction to proceed to configure a target computing system to have the compute infrastructure based on the candidate topology when the status of validation is valid, and (2) a correction instruction to generate a corrected topology when the status of validation is invalid.

2. The non-transitory computer-readable media of claim 1, further comprising instructions that when executed by at least the processor cause the computer system to, when the status of validation indicates the candidate topology to be invalid, generate, with the validation LLM, a listing of one or more descriptions of validation errors that caused the status of validation to be invalid.

3. The non-transitory computer-readable media of claim 2, further comprising instructions that when executed by at least the processor cause the computer system to, in response to the status of status of validation indicating the candidate topology to be invalid:
populate the correction instruction based on the candidate topology, the infrastructure requirements, and the one or more descriptions of validation errors, wherein the correction instruction is configured to cause a topology generation LLM to update the candidate topology with corrections to the validation errors; and
generate, with the topology generation LLM, a corrected topology in response to the correction instruction.

4. The non-transitory computer-readable media of claim 1, wherein the candidate topology is a physical infrastructure topology, further comprising instructions that when executed by at least the processor cause the computer system to determine that there are one or more overboard errors in which the candidate topology unnecessarily exceeds the infrastructure requirements.

5. The non-transitory computer-readable media of claim 1, wherein the candidate topology is a deployment specification written in deployment configuration code, and wherein the instructions to access the candidate topology further comprise instructions that when executed by at least the processor cause the computer system to convert the deployment specification to a graph written in a graph representation language.

6. The non-transitory computer-readable media of claim 1, wherein the infrastructure requirements include an additional constraint on the candidate topology to employ a specified technology.

7. The non-transitory computer-readable media of claim 1, wherein the candidate topology is a physical infrastructure topology.

8. A computer-implemented method, comprising:
accessing a candidate topology for a compute infrastructure and infrastructure requirements that are in human language and are applicable to the candidate topology;
generating a prompt from the candidate topology and infrastructure requirements, wherein the prompt is configured to cause a validation LLM to validate conformance of the candidate topology to the infrastructure requirements;
generating, with the validation LLM, a status of validation for the candidate topology in response to the prompt; and
autonomously determining, based on the status of validation, whether to (1) issue a configuration instruction to proceed to configure a target computing system to have the compute infrastructure based on the candidate topology or (2) issue a correction instruction to generate a corrected topology when the status of validation is invalid.

9. The computer-implemented method of claim 8, further comprising, when the status of validation indicates the candidate topology to be invalid, generating, with the validation LLM, a listing of one or more descriptions of validation errors that caused the status of validation to be invalid.

10. The computer-implemented method of claim 9, further comprising, in response to the status of status of validation indicating the candidate topology to be invalid:
populating the correction instruction from the candidate topology, the infrastructure requirements, and the one or more descriptions of validation errors, wherein the correction instruction is configured to cause a topology generation LLM to update the candidate topology with corrections to the validation errors; and
generating, with the topology generation LLM, the corrected topology.

11. The computer-implemented method of claim 8, wherein the candidate topology is a physical infrastructure topology, further comprising determining that there are one or more overboard errors in which the candidate topology unnecessarily exceeds the infrastructure requirements.

12. The computer-implemented method of claim 8, wherein the candidate topology is a deployment specification written in deployment configuration code, and wherein accessing the candidate topology further comprises converting the deployment specification to a graph written in a graph representation language.

13. The computer-implemented method of claim 8, wherein the infrastructure requirements include an additional constraint on the candidate topology to employ a specified product.

14. The computer-implemented method of claim 8, wherein the candidate topology is a logical infrastructure topology.

15. A computer system, comprising:
at least one processor connected to at least one memory;
one or more non-transitory computer readable media including instructions stored thereon that when executed by at least the processor cause the computer system to:
access a candidate topology for a compute infrastructure and infrastructure requirements that are in human language and are applicable to the candidate topology;
generate a prompt from the candidate topology and infrastructure requirements, wherein the prompt is configured to cause a validation LLM to validate conformance of the candidate topology to the infrastructure requirements;
generate, with the validation LLM, a status of validation for the candidate topology in response to the prompt; and
issue (1) a configuration instruction to proceed to configure a target computing system to have the compute infrastructure based on the candidate topology when the status of validation is valid, and (2) a correction instruction to generate a corrected topology when the status of validation is invalid.

16. The computing system of claim 15, wherein the instructions when executed further cause the computer system to, when the status of validation indicates the candidate topology to be invalid, generate, with the validation LLM, a listing of one or more descriptions of validation errors that caused the status of validation to be invalid.

17. The computing system of claim 16, wherein the instructions when executed further cause the computer system to, in response to the status of validation indicating the candidate topology to be invalid:
populate the correction instruction from the candidate topology, the infrastructure requirements, and the one or more descriptions of validation errors, wherein the correction instruction is configured to cause a topology generation LLM to update the candidate topology with corrections to the validation errors; and
generate, with the topology validation LLM, the corrected topology.

18. The computing system of claim 15, wherein the candidate topology is a physical infrastructure topology, and wherein the instructions when executed further cause the computer system to determine that there are one or more overboard errors in which the candidate topology unnecessarily exceeds the infrastructure requirements.

19. The computing system of claim 15, wherein the candidate topology is a deployment specification written in deployment configuration code, and wherein the instructions to access the candidate topology when executed further cause the computer system to convert the deployment specification to a graph written in a graph representation language.

20. The computing system of claim 15, wherein the candidate topology is one of a logical infrastructure topology or a physical infrastructure topology.
